(19) United States
(12) Patent Application Publication
(10) Pub. No.: US 2023/0393736 A1
(43) Pub. Date: Dec. 7, 2023

(54) MANAGING QUAD-LEVEL CELL COMPACTION STRATEGY OF A MEMORY DEVICE

(71) Applicant: MICRON TECHNOLOGY, INC., Boise, ID (US)

(72) Inventors: Vamsi Pavan Rayaprolu, Santa Clara, CA (US); Sampath K. Ratnam, Boise, ID (US); Patrick R. Khayat, San Diego, CA (US); James Fitzpatrick, Laguna Niguel, CA (US); Kishore Kumar Muchherla, Fremont, CA (US); Sivagnanam Parthasarathy, Carlsbad, CA (US); Ashutosh Malshe, Fremont, CA (US)

(21) Appl. No.: 17/830,166

(22) Filed: Jun. 1, 2022

(51) Int. Cl. G06F 3/06

(52) U.S. Cl. CPC G06F 3/0608; G06F 3/0679; G06F 3/0655

(57) ABSTRACT

One of a plurality of compaction strategies to be performed on the memory device based on at least one characteristic of a memory device is identified. Each of the plurality of compaction strategies is to program host data from at least one single-level cell (SLC) of the memory device to at least one quad-level cell (QLC) of the memory device. One or more host data from a host system is received. A compaction operation on the one or more host data using the one of the plurality of compaction strategies is performed.

### TECHNICAL FIELD

Embodiments of the disclosure relate generally to memory sub-systems, and more specifically, relate to managing quad-level cell (QLC) compaction strategy of a memory device.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory sub-system in accordance with some embodiments of the present disclosure.

FIG. 2A-C illustrates an example of performing a compaction operation based on a compaction strategy of a plurality of compaction strategies, in accordance with some embodiments of the present disclosure;

FIG. 3A-C illustrates another example of performing a compaction operation based on a compaction strategy of a plurality of compaction strategies, in accordance with some embodiments of the present disclosure;

FIG. 4A-C illustrates yet another example of performing a compaction operation based on a compaction strategy of a plurality of compaction strategies, in accordance with some embodiments of the present disclosure;

FIG. 5 is a flow diagram of an example method of managing quad-level cell (QLC) compaction strategy of a memory device, in accordance with some embodiments of the present disclosure.

FIG. 6 is a flow diagram of an example method of managing quad-level cell (QLC) compaction strategy of a memory device, in accordance with some embodiments of the present disclosure.

FIG. 7 is a block diagram of an example computer system in which embodiments of the present disclosure may operate.

### DETAILED DESCRIPTION

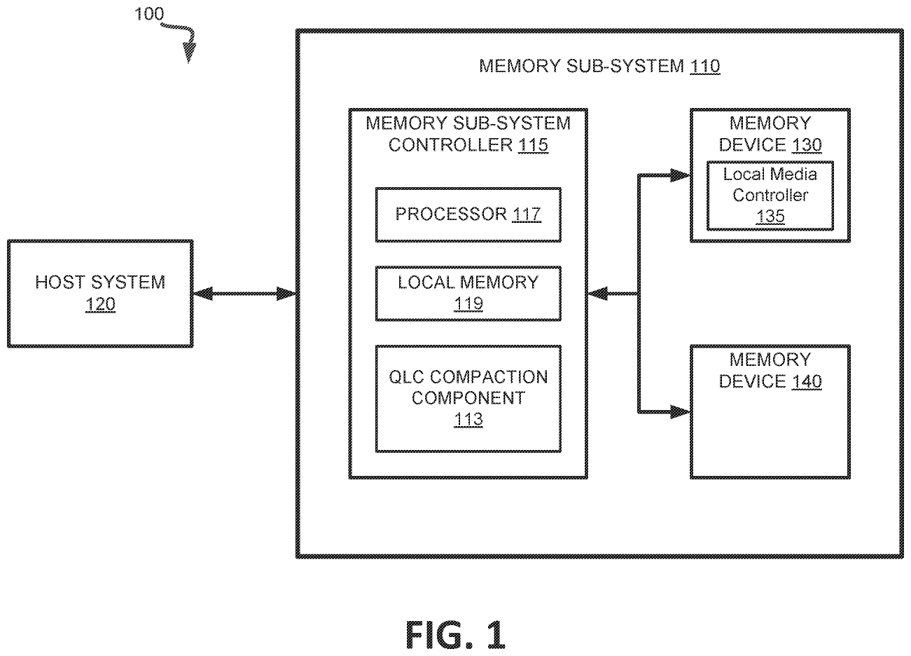

Aspects of the present disclosure are directed to managing quad-level cell (QLC) compaction strategy of a memory device. A memory sub-system can be a storage device, a memory module, or a combination of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. One example of non-volatile memory devices is a negative-and (NAND) memory device. Other examples of non-volatile memory devices are described below in conjunction with FIG. 1. A non-volatile memory device is a package of one or more dies. Each die can consist of one or more planes. For some types of non-volatile memory devices (e.g., NAND devices), each plane consists of a set of physical blocks. Each block consists of a set of pages. Each page consists of a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

A memory device can include multiple memory cells arranged in a two-dimensional or a three-dimensional grid. Memory cells are formed onto a silicon wafer in an array of columns (also hereinafter referred to as bitlines) and rows (also hereinafter referred to as wordlines). A wordline can refer to one or more rows of memory cells of a memory device that are used with one or more bitlines to generate the address of each of the memory cells. The intersection of a bitline and wordline constitutes the address of the memory cell. A block hereinafter refers to a unit of the memory device used to store data and can include a group of memory cells, a wordline group, a wordline, or individual memory cells. One or more blocks can be grouped together to form a plane of the memory device in order to allow concurrent operations to take place on each plane. The memory device can include circuitry that performs concurrent memory page accesses of two or more memory planes. For example, the memory device can include multiple access line driver circuits and power circuits that can be shared by the planes of the memory device to facilitate concurrent access of pages of two or more memory planes, including different page types. For ease of description, these circuits can be generally referred to as independent plane driver circuits. Depending on the storage architecture employed, data can be stored across the memory planes (i.e., in stripes). Accordingly, one request to read a segment of data (e.g., corresponding to one or more data addresses) can result in read operations performed on two or more of the memory planes of the memory device.

Some memory devices can be configured to store a certain number of bits per cell, such as quad-level cell (QLC) memory, which stores four bits of data in each memory cell, and make it affordable to move more applications from legacy hard disk drives to newer memory sub-systems, such as NAND-based solid-state drives (SSDs). QLC memory is particularly well-tuned for read-intensive workloads, often seen in data center applications where data is normally generated once, and then read regularly, such as to perform calculations and analysis.

Certain memory sub-systems implementing QLC memory use a standard 16-16 coarse-fine, two-pass programming algorithm. Since a QLC memory cell stores four bits of data, there are 16 possible programming levels (i.e., 2⁴) representing the possible values of those four bits of data. Programming a wordline begins by coarsely programming all 16 levels in a first pass. The objective, of this “coarse,” first pass is to program all cells rapidly to slightly below their final target programming levels. During the slower, “fine,” second pass, the memory cells are programmed to a slightly higher final target programmed voltage. Such two-pass programming minimizes cell to cell (C2C) interference, as every cell and its neighbors are nearly at their final target programmed voltage when the fine programming pass is performed, and need only be “touched-up.” The combination of not requiring precision programming in the first pass, and the minimized C2C coupling, leads to fast programming with high read window budget (RWB). Such standard 16-16 coarse-fine programming, however, requires all data to be first written to single-level cell (SLC) memory (i.e., memory cells storing one bit of data per cell) before the first pass to protect against asynchronous power loss (APL).

During a coarse state of the QLC memory (e.g., after the coarse programming pass of the QLC memory), the data stored in the QLC memory is unreadable. Some memory sub-systems store a copy of the coarse data stored in the QLC memory (e.g., the data programmed during the coarse state) into a volatile memory device (e.g., dynamic random access memory (DRAM)) until the data can be finely programmed into the QLC memory (e.g., performing the fine programming pass on the QLC memory). Accordingly, the coarse data stored in the QLC memory that otherwise would not have been readable can be read from a separate location (e.g., the volatile memory device). Typically, coarse data copied to the volatile memory devices (e.g., DRAM) can be made up of hundreds of megabytes (MBs). Thus the coarse data is required to be written (e.g., flushed) to single-level cell (SLC) memory (i.e., memory cells storing one bit of data per cell) before the first pass to protect against asynchronous power loss (APL).

Other memory sub-systems utilize SLC memory as a cache to initially (e.g., prior to a coarse programming pass of the QLC memory) program the SLC memory with the data to be written to the QLC memory so that the data may be immediately readable from the SLC memory. Thereafter, the data may be moved from the SLC memory (e.g., cache) to other memory, such as QLC memory for longer-term storage (e.g., coarse and fine programming pass). However, the SLC memory utilized as cache to program data to be written to the QLC memory may take up a significant portion of the memory device and reduce the portion of the memory device dedicated to host data. Further, in some instances data from the SLC memory is moved (e.g., programmed) to the QLC memory in a single moment (e.g., a burst) further degrading the quality of service of the memory device for enterprise and zoned namespace applications.

Aspects of the present disclosure address the above and other deficiencies by having a memory sub-system that manages quad-level cell (QLC) compaction strategy of a memory device based on the characteristics of the memory device. In particular, the memory sub-system may store (e.g., include) a plurality of compaction strategies, for example, a QLC level batch compaction strategy, an SLC level compaction strategy, and/or a partial SLC level compaction strategy. The compaction operation associated with the QLC level batch compaction strategy, as previously described, may repetitively utilize a plurality of cells configured as SLC memory as cache to initially (e.g., prior to a coarse programming pass of the QLC memory) program the SLC memory with the data to be written to the QLC memory so that the data may be immediately readable from the SLC memory. Thereafter, upon fully programming the SLC memory with enough data to fully program the QLC memory, the data may be moved from the SLC memory (e.g., cache) to the QLC memory for longer-term storage (e.g., coarse and fine programming pass). The QLC level batch compaction strategy significantly reduces the portion of the memory device dedicated to host data (e.g., by 8-25%) and provides poor quality of service management, however, it provides limited impact to the memory sub-system and provides the best garbage collection efficiency. Accordingly, client and/or mobile applications (e.g., usage) benefit the most from the tradeoffs of the QLC level batch compaction strategy.

The compaction operation associated with the SLC level compaction strategy may repetitively utilize a single cell configured as SLC memory as a cache to initially (e.g., before a coarse programming pass of the QLC memory) program the SLC memory with the data to be written to the QLC memory so that the data may be immediately readable from the SLC memory. Upon fully programming the cell configure as SLC memory, the data may be moved from the SLC memory (e.g., cache) to the QLC memory for longer-term storage (e.g., coarse and fine programming pass). Accordingly, the single cell configured as SLC memory may need to be reused multiple times to completely fill a cell configured as QLC memory. The SLC level compaction strategy provides inconsistent quality of service management and performance, however, increases, relative to the QLC level batch compaction strategy, the portion of the memory device dedicated to host data, provides limited impact to memory sub-system, and provides limited impact to garbage collection efficiency. Accordingly, enterprise applications (e.g., usage) benefit the most from the tradeoffs of the SLC level compaction strategy.

The compaction operation associated with the partial SLC level compaction strategy may utilize a single cell configured as SLC memory as a cache to initially (e.g., before a coarse programming pass of the QLC memory) program the SLC memory with the data (e.g., a wordline or page) to be written to one of a plurality of cells configured as QLC memories memory so that the data may be immediately readable from the SLC memory. Upon fully programming the data to be written to one of the plurality of cells configured as QLC memory, the data may be moved from the SLC memory (e.g., cache) to the QLC memory for longer-term storage (e.g., coarse and fine programming pass). Accordingly, the single cell configured as SLC memory initially stores data to be written to a cell configured as QLC memory QLC memories and immediately moves the data once written to the single cell configured as SLC memory to the QLC memory, thereby avoiding the need completely program the SLC memory prior to programming the QLC memory. The partial SLC level compaction strategy provides poor garbage collection efficiency. However, it provides a balance between quality of service management and performance and increases the portion of the memory device dedicated to host data. Accordingly, zoned namespace and enterprise applications (e.g., usage) benefit the most from the tradeoffs of the partial SLC level compaction strategy.

Accordingly, in some embodiments, the memory sub-system may receive input regarding the characteristics of the memory device to determine which of the plurality of compactions strategies is appropriate for the memory device. For example, based on the size of the memory device (e.g., limited storage space or need for the most possible storage space available for the memory device) and the usage of the memory device (e.g., for client, mobile, enterprise, or zoned namespace), the memory sub-system selects a compaction strategy among the plurality of compactions strategies to perform a compaction operation associated with the compaction strategy, as described in more detail herein.

Advantages of the present disclosure include, but are not limited to, providing a choice of compaction strategies based on characteristics of the memory device, thereby increasing the performance of the memory device. Further, with the selection of a compaction strategy the amount of space at the memory device allocated for caching can be significantly reduced with respect to the conventional cache implementations, thereby increasing the amount of space available as host space.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to multiple memory sub-systems 110 of different types. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a negative-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLC memories), and penta-level cells (PLCs) can store multiple bits per cell. In some embodiments, each of the memory devices 130 can include one or more arrays of memory cells such as SLC memories, MLCs, TLCs, QLC memories, PLCs or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, or electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which is a raw memory device 130 having control logic (e.g., local media controller 135) on the die and a controller (e.g., memory sub-system controller 115) for media management within the same memory device package. An example of a managed memory device is a managed NAND (MNAND) device.

The memory sub-system 110 includes a quad-level cell (QLC) compaction component 113 that can manage quad-level cell (QLC) compaction strategy of a memory device based on characteristics of the memory device. In some embodiments, the memory sub-system controller 115 includes at least a portion of the QLC compaction component 113. In some embodiments, the QLC compaction component 113 is part of the host system 110, an application, or an operating system. In other embodiments, local media controller 135 includes at least a portion of QLC compaction component 113 and is configured to perform the functionality described herein.

The QLC compaction component 113 can identify a plurality of compaction strategies stored in the memory sub-system controller 115. For example, the plurality of compaction strategies may include a QLC level batch compaction strategy, an SLC level compaction strategy, a partial SLC level compaction strategy, and/or any suitable combination of the compaction strategies. Depending on the embodiment, the QLC compaction component 113 may receive an input directed to selecting a compaction strategy among the plurality of compaction strategies based on the characteristics of the memory device. For example, the input received by the QLC compaction component 113 may be a percentage of the memory device storage space that the host intends to reserve for host data, an indication of over-provisioning of the memory device (e.g., the amount of storage space utilized for operations of the memory device), and/or intended usage of the memory device (e.g., for enterprise, client, mobile, zoned namespace (ZNS)). Depending on the embodiment, the memory sub-system 115 may provide, as input, various operation parameters of memory device 130 and/or 140 to the QLC compaction component 113 to identify an appropriate compaction strategy among the plurality of compaction strategies (e.g., autonomously without input from a user of the memory device 130 and/or 140). Accordingly, upon receiving the input, the QLC compaction component 113 can select and apply a compaction strategy (e.g., QLC level batch compaction strategy, SLC level compaction strategy, or partial SLC level compaction strategy) to host data received from the host system 120.

In one example, if the QLC memory compaction component 113 selects and applies the QLC level batch compaction strategy as the compaction strategy, the QLC compaction component 113 initializes a plurality of cells each configured as a SLC memory (e.g., a plurality of SLC memories) in memory device 130 and/or 140 as cache to initially program the host data to be written to a cell configured as a QLC memory in memory device 130 and/or 140. Once the QLC compaction component 113 determines that the plurality of SLC memories in memory device 130 and/or 140 are fully programmed, the QLC compaction component 113 initiates a copy-back operation. The copy-back operation moves the host data programmed in the plurality of SLC memories to the QLC memory using coarse and fine programming passes. In particular, the host data stored in the plurality of SLC memories is read and coarsely programmed in a first pass (quickly programmed) to the QLC memory, and then finely programmed in a second pass (slowly programmed) to the QLC memory. Once the QLC compaction component 113 identifies that the QLC memory has been fully programmed with the host data stored in the plurality of SLC memories, the QLC compaction component 113 may erase the plurality of SLC memories to continue receiving host data from the host system 120.

In another example, if the QLC compaction component 113 selects and applies the SLC level compaction strategy as the compaction strategy, the QLC compaction component 113 initializes a cell configured as a SLC memory in memory device 130 and/or 140 as cache to initially program the host data to be written to a cell configured as a QLC memory in memory device 130 and/or 140. Once the QLC compaction component 113 identifies that the SLC memory in memory device 130 and/or 140 is fully programmed, the QLC compaction component 113 initiates a copy-back operation. The copy-back operation moves the host data programmed in the SLC memory to the QLC memory using a coarse and fine programming pass. In particular, the host data stored in the SLC memory is read and then coarsely programmed in a first pass (quickly programmed) to the QLC memory, and then finely programmed in a second pass (slowly programmed) to the QLC memory. Once the QLC compaction component 113 identifies that the QLC memory has been fully programmed with the host data stored in the SLC memory, the QLC compaction component 113 may erase the SLC memory to continue receiving host data from the host system 120.

In yet another example, if the QLC compaction component 113 selects and applies the partial SLC level compaction strategy as the compaction strategy, the QLC compaction component 113 initializes a cell configured as a SLC memory in memory device 130 and/or 140 as cache to initially program the host data to be written to a cell configured as a QLC memory of a plurality of QLC memories (e.g., a plurality of cells each configured as a QLC memory) in memory device 130 and/or 140. Once the QLC compaction component 113 identifies that the host data is fully programmed in the SLC memory, the QLC compaction component 113 initiates a copy-back operation. The copy-back operation moves the host data programmed in the SLC memory to the QLC memory of the plurality of QLC memories using a coarse and fine programming pass. In particular, the host data stored in the SLC memory is read and then coarsely programmed in a first pass (quickly programmed) to the QLC memory of the plurality of QLC memories, and then finely programmed in a second pass (slowly programmed) to the QLC memory of the plurality of QLC memories. Once the QLC compaction component 113 identifies that the QLC memory of the plurality of QLC memories has been fully programmed with the host data stored in the SLC memory, the QLC compaction component 113 may erase the host data that was written to the QLC memory of the plurality of QLC memories. During the copy-back operations, the SLC memory continues to receive host data from the host system 120 to be written to the QLC memory of the plurality of QLC memories or other QLC memories of the plurality of QLC memories. Accordingly, the whole SLC memory is unlikely to be filled with host data from the host system 120 before being written to a QLC memory of the plurality of QLC memories.

Further details with regards to the operations of the QLC compaction component 113 are described below.

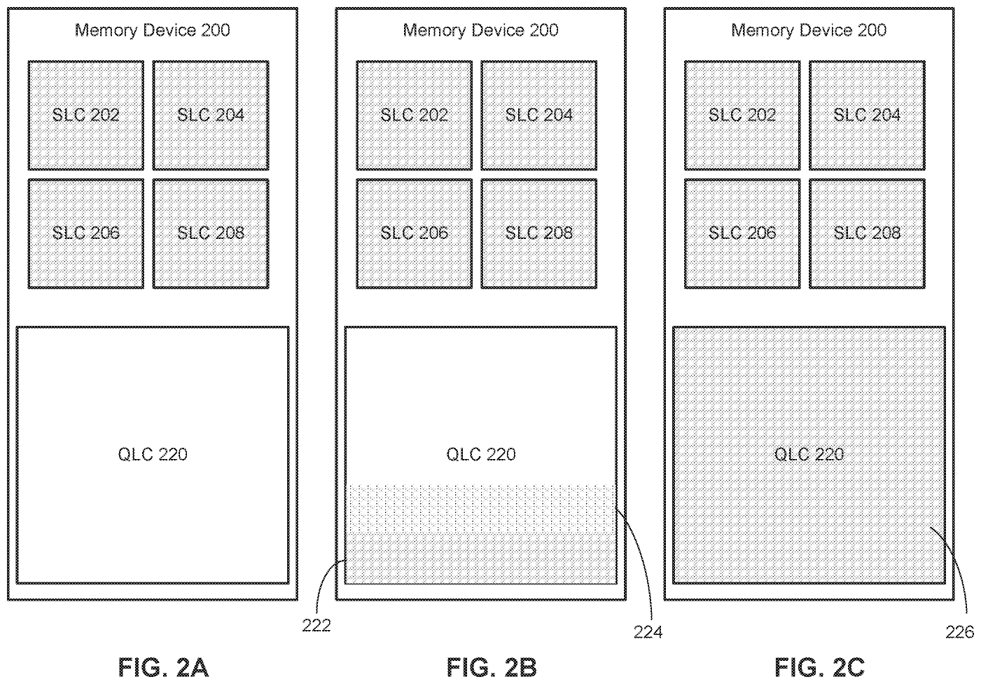

FIG. 2A-C are block diagrams illustrating performing a compaction operation based on a compaction strategy of a plurality of compaction strategies in a memory device 200. Memory device 200 can represent either memory device 130 and/or 140. Referring to FIG. 2A, based on QLC compaction component 113 setting the memory device 200 to perform compaction operations according to a QLC level batch compaction strategy, the memory device 200 initializes a plurality of single-level cell (SLC) memories (e.g., SLC 202, SLC 204, SLC 206, and SLC 208) to be associated with a quad-level cell (QLC) memory (e.g., QLC 220). Each of the plurality of SLC memories receives host data from a host system (not shown) directed to the QLC 220 of memory device 200. The plurality of SLC memories continues to receive host data from the host system directed to the QLC 220 of memory device 200, until each SLC memory of the plurality of SLC memories is filled with the host data directed to the QLC 220. In particular, the QLC 220 can store up to four SLC memories of data to fully program the QLC 220.

Referring to FIG. 2B, once the plurality of SLC memories is filled with host data directed to the QLC 220, the QLC compaction component 113 begins copying the data from the plurality of SLC memories to the QLC 220. Each SLC (e.g., SLC 202) of the plurality of SLC memories is read from the respective SLC and first coarsely programmed (e.g., first pass or rapidly programmed) to QLC 220, and then finely programmed (e.g., second pass or slowly programmed) to QLC 220. For example, the data stored in SLC 202 is coarsely and finely programmed to QLC 220, as indicated by section 222. Section 224 illustrates that the data stored in SLC 204 has been coarsely programmed to QLC 220 and requires the data stored in SLC 204 to be finely programmed to QLC 220. All data stored in the plurality of SLC memories are programmed in a burst to QLC, in particular, programming is started and completed once all data stored in the plurality of SLC memories (e.g., SLC 202, SLC 204, SLC 206, and SLC 208).

Referring to FIG. 2C, once the QLC 220 is filled with all the data stored in the plurality of SLC memories, the QLC compaction component 113 may erase the data stored in the plurality of SLC memories. In particular, since the data directed to QLC 220 and temporarily stored in the plurality of SLC memories to perform two-pass programming of QLC 220, the data temporarily stored in the plurality of SLC memories is no longer needed and can be erased to receive additional incoming data directed to the same or another QLC. In some embodiments, the memory device 200 may include an additional SLC other than the plurality of SLC memories to receive additional incoming data directed to the same or another QLC until the plurality of SLC memories are erased.

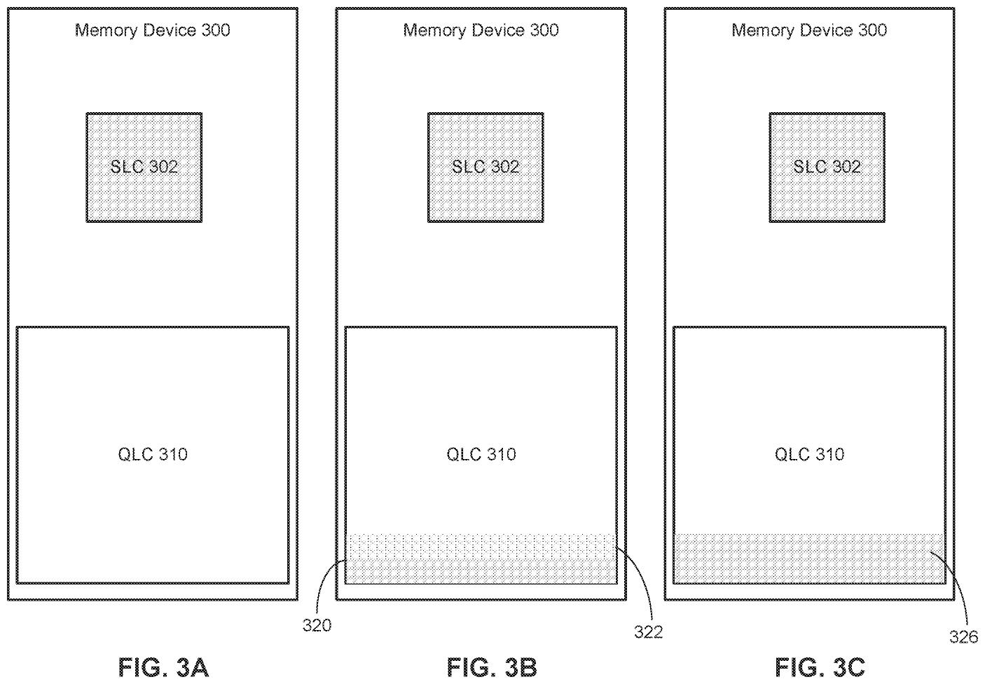

FIG. 3A-C are block diagrams illustrating performing a compaction operation based on a compaction strategy of a plurality of compaction strategies in a memory device 300. Memory device 300 can represent either memory device 130 and/or 140. Referring to FIG. 3A, based on QLC compaction component 113, setting the memory device 300 to perform compaction operations according to an SLC level batch compaction strategy, the memory device 300 initializes a single-level cell (SLC) (e.g., SLC 302) to be associated with a quad-level cell (SLC) (e.g., QLC 310). SLC 302 receives host data from a host system (not shown) directed to the QLC 310 of memory device 300. SLC 302 continues to receive host data from the host system directed to the QLC 310 until SLC 302 is filled with the host data directed to the QLC 310. Similar to QLC 220 of memory device 200, QLC 310 can store up to four SLC memories of data to be fully programmed. Accordingly, after an SLC (e.g., SLC 302) is filled and stored in a QLC (e.g., QLC 310), the data stored in SLC occupies only a quarter of the QLC memory.

Referring to FIG. 3B, once the SLC 302 is filled with host data directed to the QLC 310, the QLC compaction component 113 begins copying the data from the SLC 302 to the QLC 310. Data stored in SLC 302 is read and first coarsely programmed (e.g., first pass or rapidly programmed) to QLC 310, and then finely programmed (e.g., second pass or slowly programmed) to QLC 310. For example, the data stored in SLC 302 is coarsely and finely programmed to QLC 310, as indicated by section 320. Section 322 illustrates that a portion of the data stored in SLC 302 has been coarsely programmed to QLC 310 and requires the portion of the data to be finely programmed to QLC 310. Referring to FIG. 3C, once all the data stored in SLC 302 is fully programmed to QLC 310, the QLC compaction component 113 may erase the data stored in the SLC 302. Section 326 represents the data previously stored in SLC 302, now stored in QLC 310. In particular, since the data directed to QLC 310 and temporarily stored in the SLC 302 to perform two-pass programming of QLC 310, the data temporarily stored in the SLC 302 is no longer needed and can be erased to receive additional incoming data directed to the same or another QLC. In some embodiments, the memory device 300 may include an additional SLC other than the SLC 302 to receive additional incoming data directed to the same or another QLC until the SLC 302 is erased.

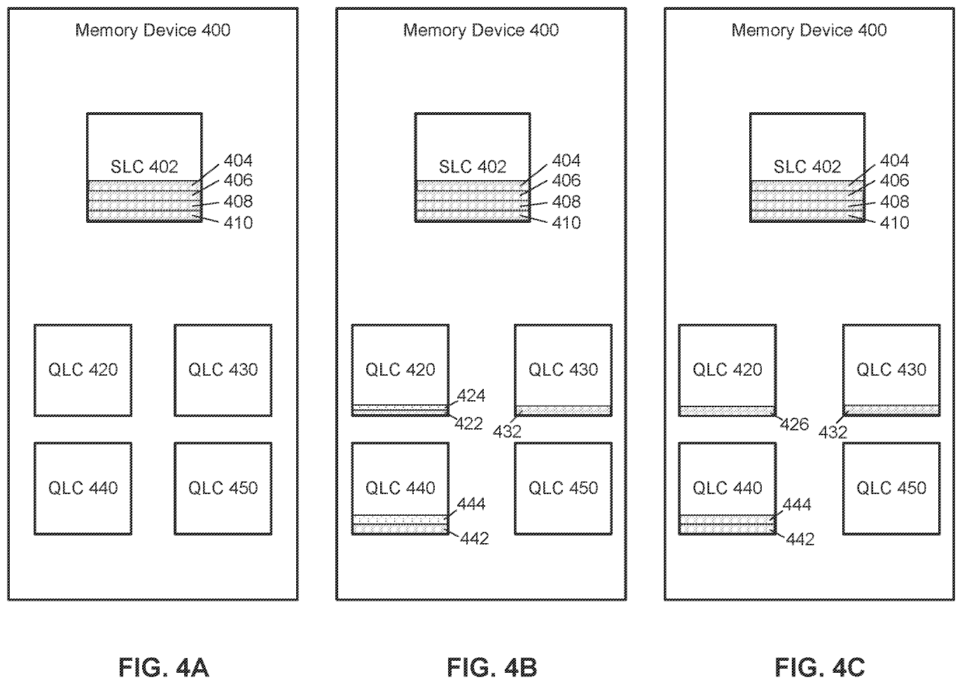

FIG. 4A-C are block diagrams illustrating performing a compaction operation based on a compaction strategy of a plurality of compaction strategies in a memory device 400. Memory device 400 can represent either memory device 130 and/or 140. Referring to FIG. 4A, based on QLC compaction component 113 setting the memory device 400 to perform compaction operations according to a partial SLC level batch compaction strategy, the memory device 400 initializes a single-level cell (SLC) (e.g., SLC 402) to be associated with a plurality of quad-level cell (SLC) (e.g., QLC 420, QLC 430, QLC 440, and QLC 450). SLC 402 receives host data from a host system (not shown) directed to the plurality of QLC memories of memory device 300. SLC 402 continues to receive and program host data (e.g., wordline 404, wordline 406, wordline 408, or wordline 410) from the host system directed to the plurality of QLC memories. Similar to QLC 220 of memory device 200 and QLC 310 of memory device 300, the plurality of QLC memories can each store up to four SLC memories of data to be fully programmed.

Referring to FIG. 4B, after each wordline (e.g., wordline 404) directed to a QLC of the plurality of QLC memories (e.g., QLC 420) is fully programmed to SLC 402, the QLC compaction component 113 begins copying the wordline (e.g., wordline 404) from the SLC 402 to the QLC 420. The wordline stored in SLC 402 is read and first coarsely programmed (e.g., first pass or rapidly programmed) to QLC 420, then finely programmed (e.g., second pass or slowly programmed) to QLC 420. For example, wordline 404 stored in SLC 402 and directed to QLC 420 is coarsely as reflected by portion 424 of QLC 420 and then finely programmed to QLC 420 as reflected by portion 424, which indicates that all the data associated with wordline 404 is not fully programmed to QLC 420. Wordline 406 stored in SLC 402 and directed to QLC 430 is coarsely and finely programmed to QLC 430 as reflected by portion 432 of QLC 430. Wordline 408 stored in SLC 402 and directed to QLC 440 is coarsely and finely programmed to QLC 440 as reflected by portion 442 of QLC 440. Wordline 410 stored in SLC 402 and directed to QLC 440 is coarsely programmed, but not yet finely programmed, to QLC 440 as reflected by portion 444 of QLC 440. Accordingly, SLC 402 may receive wordlines (or pages) directed to a QLC of a plurality of QLC memories and perform two-pass programming without requiring an SLC (e.g., SLC 402) to be filled or a plurality of SLC memories similar to FIG. 2A-C to be filled prior to programming a QLC.

Referring to FIG. 4C, once a wordline (e.g., wordline 404, wordline 406, wordline 408, or wordline 410) stored in SLC 402 is fully programmed, a QLC of the plurality of QLC memories (e.g., QLC 420, QLC 430, QLC 440, or QLC 450), the QLC compaction component 113 may erase the wordline stored in the SLC 402. Portion 426 of QLC 420 represents wordline 404, previously stored in SLC 402, now stored in QLC 420. Portion 426 of QLC 420 represents wordline 404, previously stored in SLC 402, now fully programmed in QLC 420. Portion 432 of QLC 430 represents wordline 406, previously stored in SLC 402, now fully programmed in QLC 430. Portions 442 and 444 of QLC 440 represent wordlines 408 and 410, respectively, previously stored in SLC 402, now fully programmed in QLC 440. Since the wordline (e.g., wordline 404, wordline 406, wordline 408, or wordline 410) directed a QLC of the plurality of QLC memories (e.g., QLC 420, QLC 430, QLC 440, or QLC 450) and temporarily stored in the SLC 402 to perform two-pass programming of the QLC memory of the plurality of QLC memories (e.g., QLC 420, QLC 430, QLC 440, or QLC 450), the data temporarily stored in the SLC 402 is no longer needed and can be erased to receive additional incoming data directed to the same or another QLC of the plurality of QLC memories. Typically, since the SLC memory is being erased as each wordline is fully programmed in the SLC memory, no additional SLC is needed to receive additional incoming data directed to the same or another QLC of the plurality of QLC memories until the SLC 402 is erased, however, an additional SLC other than the SLC 402 may be implemented.

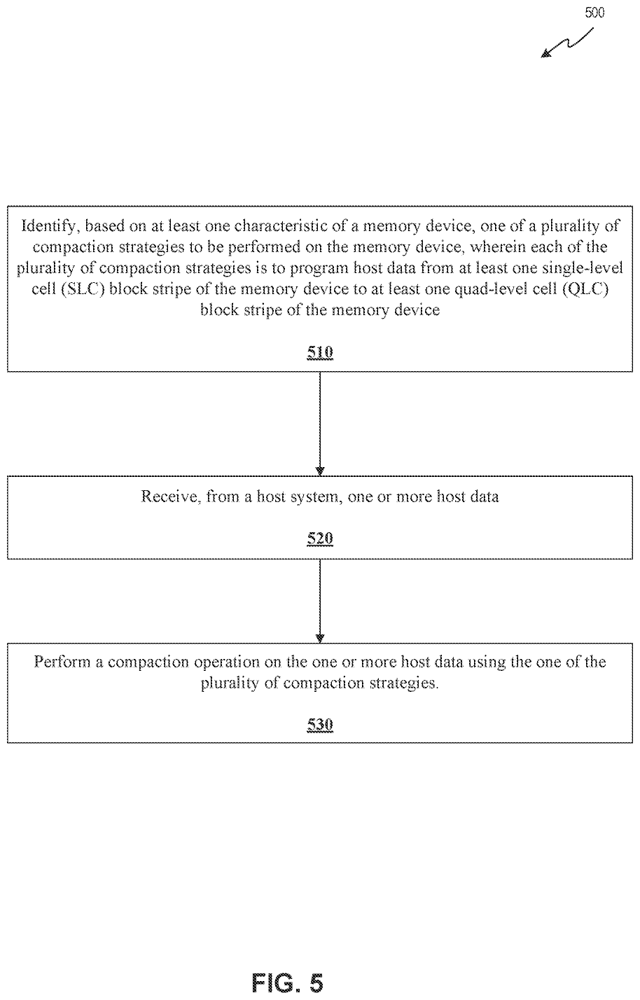

FIG. 5 is a flow diagram of an example method 500 to manage quad-level cell (QLC) compaction strategy of a memory device, in accordance with some embodiments of the present disclosure. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500 is performed by the QLC compaction component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 510, the processing logic identifies, based on at least one characteristic of a memory device, one of a plurality of compaction strategies to be performed on the memory device. Depending on the embodiment, the at least one characteristic of the memory device may be at least one of a size of the memory device or usage of the memory device. As previously described, the at least one characteristic of the memory device may be a percentage of the memory device storage space that the host intends to reserve towards host data, an indication of an over-provisioning of the memory device (e.g., the amount of storage space utilized for operations of the memory device), and/or intended usage of the memory device (e.g., for enterprise, client, mobile, zoned namespace (ZNS)). Each of the plurality of compaction strategies is to program host data from at least one single-level cell (SLC) of the memory device to at least one quad-level cell (QLC) of the memory device. As previously described, the plurality of compaction strategies may include a QLC level batch compaction strategy, an SLC level compaction strategy, a partial SLC level compaction strategy, or any suitable combination of the compaction strategies.

In some embodiments, to identify the one of the plurality of compaction strategies, the processing logic receives an input selection of the compaction strategy of the plurality of compaction strategies. Depending on the embodiment, the input selection may be based on at least one of a size of the memory device or usage of the memory device. Responsive to receiving the input selection, the processing logic selects, based on the input selection, the compaction strategy among the plurality of compaction strategies. As previously described, as an example, the input received may be a percentage of the memory device storage space that the host intends to reserve for host data, an indication of over-provisioning of the memory device (e.g., the amount of storage space utilized for operations of the memory device), and/or intended usage of the memory device (e.g., for enterprise, client, mobile, zoned namespace (ZNS)). The input may be various operation parameters of the memory device, received by the memory sub-system, to identify an appropriate compaction strategy among the plurality of compaction strategies (e.g., autonomously without input from a user of the memory device).

At operation 520, the processing logic receives, from a host system, one or more host data. At operation 530, the processing logic performs a compaction operation on the one or more host data using the one of the plurality of compaction strategies. As previously described, upon receiving the input, the processing logic selects and applies the compaction strategy (e.g., QLC level batch compaction strategy, SLC level compaction strategy, or partial SLC level compaction strategy) to host data received from the host system.

In some embodiments, the one of the plurality of compaction strategies may be a QLC level batch compaction strategy. As previously described, prior to performing the compaction strategy, the processing logic initializes a plurality of SLC memories as cache to initially program the host data to be written to a QLC. Accordingly, to perform the compaction operation on the one or more host data, the processing logic determines that four SLC memories are fully programmed with the one or more host data. Responsive to determining that four SLC memories are fully programmed with the one or more host data, the processing logic programs a QLC corresponding with the one or more host data stored in the four SLC memories (e.g., copy-back operation or compaction operation). As previously described, the copy-back operation moves the host data programmed in the plurality of SLC memories to the QLC memory using a coarse and fine programming pass by reading the host data stored in the plurality of SLC memories, then coarsely programming in a first pass (quickly programmed) to the QLC memory, and then finely programming in a second pass (slowly programmed) to the QLC memory. Depending on the embodiment, once the QLC memory has been fully programmed with the host data stored in the plurality of SLC memories, the plurality of SLC memories may be erased to continue receiving host data from the host system.

In some embodiments, the one of the plurality of compaction strategies may be an SLC level compaction strategy. As previously described, prior to performing the compaction strategy, the processing logic initializes an SLC as cache to initially program the host data to be written to a QLC. Accordingly, to perform the compaction operation on the one or more host data, the processing logic determines that an SLC is fully programmed with the one or more host data. Responsive to determining that four SLC memories are fully programmed with the one or more host data, the processing logic programs a QLC with the one or more host data stored in the SLC memory (e.g., copy-back operation or compaction operation). As previously described, the copy-back operation moves the host data programmed in the SLC memory to the QLC memory using a coarse and fine programming pass by reading the host data stored in the SLC memory, then coarsely programming in a first pass (quickly programmed) to the QLC memory, and then finely programming in a second pass (slowly programmed) to the QLC memory. Depending on the embodiment, once the QLC memory has been fully programmed with the host data stored in the SLC memory, the SLC memory is erased to continue receiving host data from the host system.

In some embodiments, the one of the plurality of compaction strategies may be a partial SLC level compaction strategy. As previously described, prior to performing the compaction strategy, the processing logic initializes an SLC as cache to initially program the host data to be written to a QLC of a plurality of QLC memories. In other words, each SLC is associated with a plurality of QLC memories. Accordingly, to perform the compaction operation on the one or more host data, for each host data of the one or more host data programmed to an SLC, the processing logic programs a QLC of a plurality of QLC memories with a respective host data stored in the SLC memory (e.g., the copy-back operation). As previously described, the copy-back operation moves the host data programmed in the SLC memory to the QLC memory of the plurality of QLC memories using a coarse and fine programming pass by reading the host data stored in the SLC memory, then coarsely programming in a first pass (quickly programmed) to the QLC memory of the plurality of QLC memories, and then finely programming in a second pass (slowly programmed) to the QLC memory of the plurality of QLC memories. Depending on the embodiment, once the QLC memory of the plurality of QLC memories has been fully programmed with the host data stored in the SLC memory, the host data that was written to the QLC memory of the plurality of QLC memories is erased. During the copy-back operations, the SLC memory continues to receive host data from the host system to be written to the QLC memory of the plurality of QLC memories or other QLC memories of the plurality of QLC memories.

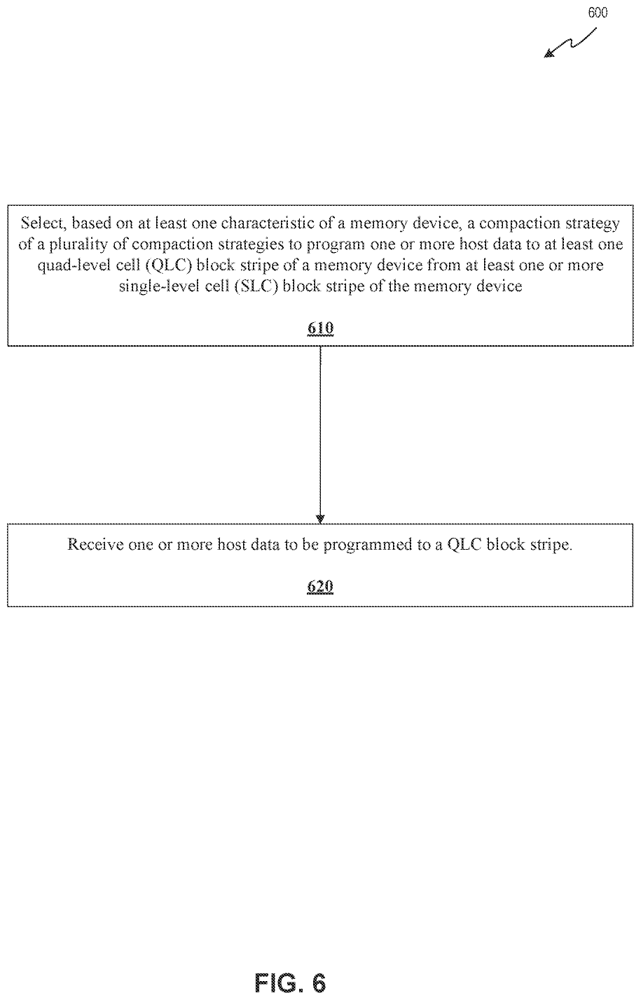

FIG. 6 is a flow diagram of an example method 600 to manage quad-level cell (QLC) compaction strategy of a memory device, in accordance with some embodiments of the present disclosure. The method 600 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 600 is performed by the QLC compaction component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 610, the processing logic selects, based on at least one characteristic of a memory device, a compaction strategy of a plurality of compaction strategies to program one or more host data to at least one quad-level cell (QLC) of a memory device from at least one or more single-level cell (SLC) of the memory device. As previously described, the at least one characteristic of the memory device may be a percentage of the memory device storage space that the host intends to reserve towards host data, an indication of an over-provisioning of the memory device (e.g., the amount of storage space utilized for operations of the memory device), and/or intended usage of the memory device (e.g., for enterprise, client, mobile, zoned namespace (ZNS)). The plurality of compaction strategies may include a QLC level batch compaction strategy, an SLC level compaction strategy, a partial SLC level compaction strategy, or any suitable combination of the compaction strategies.

At operation 620, the processing logic receives one or more host data to be programmed to a QLC. In one embodiment, responsive to receiving the one or more host data to be programmed to a QLC, the processing logic identifies that the selected compaction strategy is a QLC level compaction strategy. As previously described, prior to performing the compaction strategy, the processing logic initializes a plurality of SLC memories as cache to initially program the host data to be written to a QLC. Responsive to fully programming four SLC memories of the memory device associated with the QLC memory, the processing logic programs the QLC memory with the one or more host data of the four SLC memories (e.g., copy-back operation or compaction operation). As previously described, the copy-back operation moves the host data programmed in the four SLC memories to the QLC memory using a coarse and fine programming pass by reading the host data stored in the four SLC memories, then coarsely programming in a first pass (quickly programmed) to the QLC memory, and then finely programming in a second pass (slowly programmed) to the QLC memory. Depending on the embodiment, once the QLC memory has been fully programmed with the host data stored in the four SLC memories, the four SLC memories may be erased to continue receiving host data from the host system.

In another embodiment, responsive to receiving the one or more host data to be programmed to a QLC, the processing logic identifies that the selected compaction strategy is an SLC level compaction strategy. As previously described, prior to performing compaction strategy, the processing logic initializes an SLC as cache to initially program the host data to be written to a QLC. Responsive to fully programming an SLC of the memory device associated with the QLC memory, the processing logic programs the QLC memory with the one or more host data of the SLC memory (e.g., copy-back operation or compaction operation). As previously described, the copy-back operation moves the host data programmed in the SLC memory to the QLC memory using a coarse and fine programming pass by reading the host data stored in the SLC memory, then coarsely programming in a first pass (quickly programmed) to the QLC memory, and then finely programming in a second pass (slowly programmed) to the QLC memory. Depending on the embodiment, once the QLC memory has been fully programmed with the host data stored in the SLC memory, the SLC memory is erased to continue receiving host data from the host system.

In yet another embodiment, responsive to receiving the one or more host data to be programmed to a QLC, the processing logic identifies that the selected compaction strategy is a partial SLC level compaction strategy. As previously described, prior to performing the compaction strategy, the processing logic initializes an SLC as cache to initially program the host data to be written to a QLC of a plurality of QLC memories. In other words, each SLC is associated with a plurality of QLC memories. Responsive to programming a host data of the one or more host data to an SLC of the memory device associated with the QLC memory, the processing logic programs the QLC memory associated with the host data of the SLC memory (e.g., the copy-back operation). As previously described, the copy-back operation moves the host data programmed in the SLC memory to the QLC memory of the plurality of QLC memories using a coarse and fine programming pass by reading the host data stored in the SLC memory, then coarsely programming in a first pass (quickly programmed) to the QLC memory of the plurality of QLC memories, and then finely programming in a second pass (slowly programmed) to the QLC memory of the plurality of QLC memories. Depending on the embodiment, once the QLC memory of the plurality of QLC memories has been fully programmed with the host data stored in the SLC memory, the host data that was written to the QLC memory of the plurality of QLC memories is erased. During the copy-back operations, the SLC memory continues to receive host data from the host system to be written to the QLC memory of the plurality of QLC memories or other QLC memories of the plurality of QLC memories.

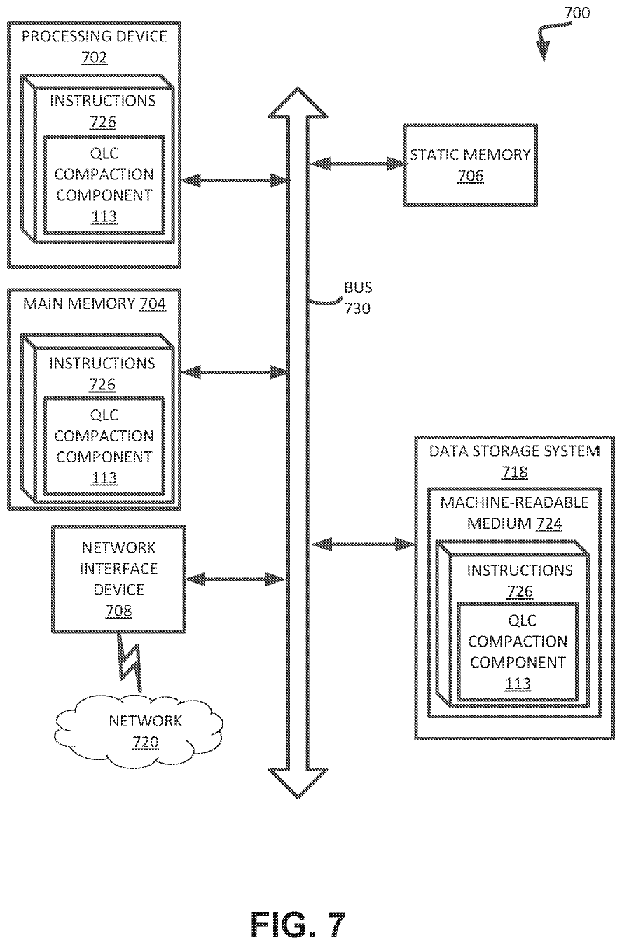

FIG. 7 illustrates an example machine of a computer system 700 within which a set of instructions, for causing the machine to perform any one or more of the methodologies discussed herein, can be executed. In some embodiments, the computer system 700 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the QLC compaction component 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processing device 702, a main memory 704 (e.g., read-only memory (ROM), flash memory, dynamic random access memory (DRAM) such as synchronous DRAM (SDRAM) or RDRAM, etc.), a static memory 706 (e.g., flash memory, static random access memory (SRAM), etc.), and a data storage system 718, which communicate with each other via a bus 730.

Processing device 702 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 702 can also be one or more special-purpose processing devices such as an application specific integrated circuit (ASIC), a field programmable gate array (FPGA), a digital signal processor (DSP), network processor, or the like. The processing device 702 is configured to execute instructions 726 for performing the operations and steps discussed herein. The computer system 700 can further include a network interface device 708 to communicate over the network 720.

The data storage system 718 can include a machine-readable storage medium 724 (also known as a computer-readable medium) on which is stored one or more sets of instructions 726 or software embodying any one or more of the methodologies or functions described herein. The instructions 726 can also reside, completely or at least partially, within the main memory 704 and/or within the processing device 702 during execution thereof by the computer system 700, the main memory 704 and the processing device 702 also constituting machine-readable storage media. The machine-readable storage medium 724, data storage system 718, and/or main memory 704 can correspond to the memory sub-system 110 of FIG. 1.

In one embodiment, the instructions 726 include instructions to implement functionality corresponding to a QLC compaction component (e.g., the QLC compaction component 113 of FIG. 1). While the machine-readable storage medium 724 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method comprising:
identifying, based on at least one characteristic of a memory device, one of a plurality of compaction strategies to be performed on the memory device, wherein each of the plurality of compaction strategies is to program host data from at least one single-level cell (SLC) of the memory device to at least one quad-level cell (QLC) of the memory device;
receiving, from a host system, one or more host data; and
performing a compaction operation on the one or more host data using the one of the plurality of compaction strategies.

2. The method of claim 1, wherein the one of the plurality of compaction strategies comprises a QLC level batch compaction strategy, and wherein performing the compaction operation on the one or more host data comprises:
determining that four SLC memories are fully programmed with the one or more host data; and
programming a QLC corresponding with the one or more host data stored in the four SLC memories.

3. The method of claim 1, wherein the one of the plurality of compaction strategies comprises an SLC level compaction strategy, and wherein performing the compaction operation on the one or more host data comprises:
determining that an SLC is fully programmed with the one or more host data; and
programming a QLC with the one or more host data stored in the SLC memory.

4. The method of claim 1, wherein the one of the plurality of compaction strategies comprises a partial SLC level compaction strategy, and wherein performing the compaction operation on the one or more host data comprises:
for each host data of the one or more host data programmed to an SLC, programming a QLC of a plurality of QLC memories with a respective host data stored in the SLC memory.

5. The method of claim 4, wherein the SLC memory is associated with the plurality of QLC memories.

6. The method of claim 1, wherein identifying the one of the plurality of compaction strategies further comprises:
receiving an input selection of the compaction strategy of the plurality of compaction strategies; and
selecting, based on the input selection, the compaction strategy.

7. The method of claim 6, wherein the input selection is based on at least one of a size of the memory device or usage of the memory device.

8. The method of claim 1, wherein the at least one characteristic of the memory device comprises at least one of a size of the memory device or usage of the memory device.

9. A system comprising:
a non-volatile memory device; and
a processing device, operatively coupled with the non-volatile memory device, to perform operations comprising:
identifying, based on at least one characteristic of a memory device, one of a plurality of compaction strategies to be performed on the memory device, wherein each of the plurality of compaction strategies is to program host data from at least one single-level cell (SLC) of the memory device to at least one quad-level cell (QLC) of the memory device;
receiving, from a host system, one or more host data; and
performing a compaction operation on the one or more host data using the one of the plurality of compaction strategies.

10. The system of claim 9, wherein the one of the plurality of compaction strategies comprises a QLC level batch compaction strategy, and wherein performing the compaction operation on the one or more host data comprises:
determining that four SLC memories are fully programmed with the one or more host data; and
programming a QLC corresponding with the one or more host data stored in the four SLC memories.

11. The system of claim 9, wherein the one of the plurality of compaction strategies comprises an SLC level compaction strategy, and wherein performing the compaction operation on the one or more host data comprises:
determining that an SLC is fully programmed with the one or more host data; and
programming a QLC with the one or more host data stored in the SLC memory.

12. The system of claim 9, wherein the one of the plurality of compaction strategies comprises a partial SLC level compaction strategy, and wherein performing the compaction operation on the one or more host data comprises:
for each host data of the one or more host data programmed to an SLC, programming a QLC of a plurality of QLC memories with a respective host data stored in the SLC memory.

13. The system of claim 12, wherein the SLC memory is associated with the plurality of QLC memories.

14. The system of claim 9, wherein identifying the one of the plurality of compaction strategies further comprises:
receiving an input selection of the compaction strategy of the plurality of compaction strategies; and
selecting, based on the input selection, the compaction strategy.

15. The system of claim 14, wherein the input selection is based on one of: a size of the memory device or usage of the memory device.

16. The system of claim 9, wherein the at least one characteristic of the memory device comprises at least one of a size of the memory device or usage of the memory device.

17. A non-transitory computer-readable storage medium comprising instructions that, when executed by a processing device, cause the processing device to perform operations comprising:
selecting, based on at least one characteristic of a memory device, a compaction strategy of a plurality of compaction strategies to program one or more host data to at least one quad-level cell (QLC) of a memory device from at least one or more single-level cell (SLC) of the memory device; and
receiving one or more host data to be programmed to a QLC.

18. The non-transitory computer-readable medium of claim 17, wherein receiving the one or more host data to be programmed to the QLC memory includes:
identifying that the selected compaction strategy is a QLC level compaction strategy;
responsive to fully programming four SLC memories of the memory device associated with the QLC memory, programming the QLC memory with the one or more host data of the four SLC memories.

19. The non-transitory computer-readable medium of claim 18, wherein receiving the one or more host data to be programmed to the QLC memory includes:
identifying that the selected compaction strategy is an SLC level compaction strategy;
responsive to fully programming an SLC of the memory device associated with the QLC memory, programming the QLC memory with the one or more host data of the SLC memory. The non-transitory computer-readable medium of claim 17, wherein receiving the one or more host data to be programmed to the QLC memory includes:
identifying that the selected compaction strategy is a partial SLC level compaction strategy;
responsive to programming a host data of the one or more host data to an SLC of the memory device associated with the QLC memory, programming the QLC memory associated with the host data of the SLC memory.
